(19) United States
(12) Patent Application Publication
(10) Pub. No.: US 2024/0257446 A1
(43) Pub. Date: Aug. 1, 2024

(54) VIRTUAL SCENE RENDERING METHOD AND APPARATUS, DEVICE, AND MEDIUM

(71) Applicant: Tencent Technology (Shenzhen) Company Limited, Shenzhen (CN)

(72) Inventors: Chao LI, Shenzhen (CN); Yuanheng LI, Shenzhen (CN)

(21) Appl. No.: 18/630,930

(22) Filed: Apr. 9, 2024

Related U.S. Application Data
(63) Continuation of application No. PCT/CN2023/101570, filed on Jun. 21, 2023.

(30) Foreign Application Priority Data
Aug. 18, 2022 (CN) 202210993392.0

(51) Int. Cl. G06T 15/50

(52) U.S. Cl. CPC G06T 15/50

(57) ABSTRACT

This application relates to a virtual scene rendering method performed by a computer device. The method includes: determining a target light source type among a plurality of candidate light source types for a target point in a virtual scene; performing light source sampling on the target point to obtain a target light source that matches the target light source type; and rendering the target point based on the target light source.

### CROSS-REFERENCE TO RELATED APPLICATIONS

This application is a continuation application of PCT Patent Application No. PCT/CN2023/101570, entitled “VIRTUAL SCENE RENDERING METHOD AND APPARATUS, DEVICE, AND MEDIUM” filed on Jun. 21, 2023, which claims priority to Chinese Patent Application No. 2022109933920, entitled “LIGHTING RENDERING METHOD AND APPARATUS, DEVICE, AND MEDIUM” filed with the China National Intellectual Property Administration on Aug. 18, 2022, all of which is incorporated herein by reference in its entirety.

### FIELD OF THE TECHNOLOGY

This application relates to the field of image rendering technologies, and in particular, to a virtual scene rendering method and apparatus, a device, and a medium.

### BACKGROUND OF THE DISCLOSURE

With the development of image processing technologies, a lighting rendering technology has emerged. The lighting rendering technology is a technology for lighting rendering of an object in a virtual scene. For example, the lighting rendering technology can implement lighting rendering of an object in a game scene. In conventional technologies, a light source in a scene is usually sampled in a random and uniform light source sampling manner. However, random and uniform sampling of a light source is only applicable to a scene with only one light source. Yet, there is usually more than one light source type in a virtual scene. When there are a plurality of types of light sources in a virtual scene, if the light sources in the scene are to be directly sampled in a random and uniform light source sampling manner, only one of the light sources is to be sampled, resulting in poor quality of an image after rendered.

### SUMMARY

On this basis, it is necessary to provide a virtual scene rendering method and apparatus, a device, and a medium with respect to the foregoing technical problem.

According to a first aspect, this application provides a virtual scene rendering method, performed by a terminal, including:
determining a target light source type among a plurality of candidate light source types for a target point in a virtual scene;
performing light source sampling on the target point to obtain a target light source that matches the target light source type; and
rendering the target point based on the target light source.

According to a third aspect, this application provides a computer device, including a memory and one or more processors, the memory having computer-readable instructions stored therein, and the computer-readable instructions, when executed by the processor, causing the computer device to implement steps in method embodiments of this application.

According to a fourth aspect, this application provides one or more non-transitory computer-readable storage media, having computer-readable instructions stored thereon, and the computer-readable instructions, when being executed by one or more processors of a computer device, causing the computer device to implement steps in method embodiments of this application.

Details of one or more embodiments of this application are provided in the accompanying drawings and descriptions below. Other features, objectives, and advantages of this application become apparent from the specification, the drawings, and the claims.

### BRIEF DESCRIPTION OF THE DRAWINGS

To describe the technical solutions of embodiments of this application more clearly, the following briefly introduces the accompanying drawings required for describing the embodiments. Apparently, the accompanying drawings in the following description show only some embodiments of this application, and a person of ordinary skill in the art may still derive other drawings from these accompanying drawings without an inventive effort.

FIG. 1 is a diagram of an application environment of a virtual scene rendering method in an embodiment.

FIG. 2 is a flowchart of a virtual scene rendering method in an embodiment.

FIG. 3 is a schematic diagram of light source sampling in an embodiment.

FIG. 4 is a schematic diagram of construction of candidate spatial grids in an embodiment.

FIG. 5 is a schematic diagram of a configuration interface for a virtual light source in an embodiment.

FIG. 6 is a schematic diagram of a luminous object light source bounding volume hierarchy in an embodiment.

FIG. 7 is a schematic diagram of calculating a node sampling weight in an embodiment.

FIG. 8 is a flowchart of construction of candidate spatial grids and a light source bounding volume hierarchy in an embodiment.

FIG. 9 is a flowchart of light source sampling in an embodiment.

FIG. 10 is a schematic diagram of comparison between a lighting rendering result corresponding to a virtual scene rendering method of this application and a lighting rendering result corresponding to a conventional virtual scene rendering method in an embodiment.

FIG. 11 is a schematic diagram of comparison of a lighting rendering result corresponding to a virtual scene rendering method of this application and a lighting rendering result corresponding to a conventional virtual scene rendering method in another embodiment.

FIG. 12 is a flowchart of time-consumption testing for a virtual scene rendering method of this application and a conventional virtual scene rendering method based on a simple virtual scene in an embodiment.

FIG. 13 is a flowchart of a virtual scene rendering method in another embodiment.

FIG. 14 is a block diagram of a structure of a virtual scene rendering apparatus in an embodiment.

FIG. 15 is a diagram of an internal structure of a computer device in an embodiment.

### DESCRIPTION OF EMBODIMENTS

To make the objectives, technical solutions, and advantages of this application clearer, the following further describes this application in detail with reference to the accompanying drawings and the embodiments. It is to be understood that the specific embodiments described herein are merely for explaining this application but are not intended to limit this application.

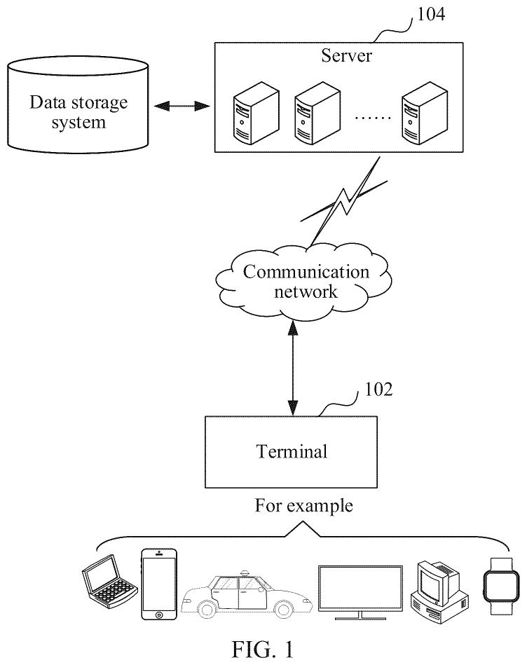

A virtual scene rendering method provided in this application is applicable to an application environment shown in FIG. 1. A terminal 102 communicates with a server 104 via a network. A data storage system may store data that the server 104 needs to process. The data storage system may be integrated on the server 104 or placed on cloud or on another server. The terminal 102 may be, but is not limited to, any desktop computer, a notebook computer, a smart phone, a tablet, an Internet of Things device, and a portable wearable device. The Internet of Things device may be a smart speaker, a smart TV, a smart air conditioner, a smart on-board device, or the like. The portable wearable device may be a smart watch, a smart band, a headset device, or the like. The server 104 may be an independent physical server, or may be a server cluster or a distributed system including a plurality of physical servers, or may be a cloud server that provides basic cloud computing services such as a cloud service, a cloud database, cloud computing, a cloud function, cloud storage, a network service, cloud communications, a middleware service, a domain name service, a security service, a CDN, big data, and an artificial intelligence platform. The terminal 102 may be directly or indirectly connected to the server 104 via wired or wireless communications. This is not limited in this application.

For a target point in a virtual scene, the terminal 102 may determine a target light source type among a plurality of candidate light source types, and perform light source sampling on the target point to obtain a target light source that matches the target light source type. Further, the terminal 102 may render the target point based on the target light source.

It is to be understood that the terminal 102 may directly display a rendered image. Alternatively, the terminal 102 may send the rendered image to the server 104. The server 104 may receive and store the rendered image. This is not limited in this embodiment. It is to be understood that the application scenario in FIG. 1 is merely for illustrative description, and is not intended for limitation.

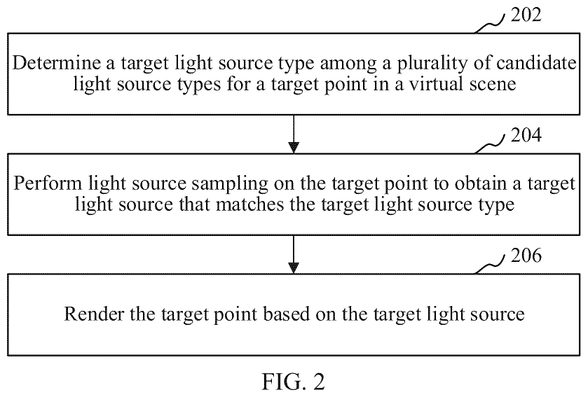

In an embodiment, as shown in FIG. 2, a virtual scene rendering method is provided. This embodiment is described using an example in which the method is applied to the terminal 102 in FIG. 1, including the following steps.

Step 202: Determine a target light source type among a plurality of candidate light source types for a target point in a virtual scene.

In one embodiment, the plurality of candidate light source types are obtained by classifying light sources in the virtual scene. The plurality of candidate light source types include a virtual light source type and a physical light source type. In some embodiments, the physical light source type include luminous object light source type. In other words, the plurality of candidate light source types include the virtual light source type and the luminous object light source type. The physical light source type is a type of custom light sources. Light sources in the virtual scene refer to preset light sources in the virtual scene. It is to be understood that in embodiments of this application, the terminal first determines the target light source type among the plurality of candidate light source types, then determines a target light source that matches the target light source type, and finally renders the target point by using the target light source. It is to be understood that the light sources are not used in the virtual scene during sampling (before rendering).

In an embodiment, for the target point in the virtual scene, the terminal may determine a target light source type of current light source sampling among a plurality of candidate light source types corresponding to the virtual scene in each light source sampling performed on the target point. The plurality of candidate light source types corresponding to the virtual scene refer to types of light sources included in the virtual scene. It is to be understood that the types of light sources included in the virtual scene have correspondences with the virtual scene.

In an embodiment, for the target point in the virtual scene, before each light source sampling performed on the target point, the terminal may determine a target light source type among a plurality of candidate light source types.

The virtual scene is a to-be-rendered virtual scene. For example, a game scene in an electronic game is a virtual scene. The target point is a to-be-rendered point in the virtual scene. It is to be understood that, after a rendered image is obtained by rendering the virtual scene, the target point in the virtual scene is a pixel point in the rendered image. A light source type is a type of light sources. Light source types are obtained by classifying light sources in the virtual scene. It is to be understood that there are a plurality of light source types, that is, a plurality of types of light sources, in the virtual scene. The plurality of candidate light source types include at least a virtual light source type and a luminous object light source type. The virtual light source type is a type of virtual light sources. It is to be understood that a light source in the virtual scene that matches the virtual light source type is a virtual light source. The virtual light source is a basic type of light source defined in a rendering engine. The virtual light source defined in the rendering engine includes at least one of directional light, a point light source, a spotlight, a rectangular surface light source, and the like. The luminous object light source type is a type of a luminous object light source. It is to be understood that a light source in the virtual scene that matches the luminous object light source type is a luminous object light source. The luminous object light source is an object having a self-luminous attribute in the virtual scene. In the rendering engine, objects having a self-luminous attribute in the virtual scene are formed by self-luminous triangle meshes. A self-luminous triangle mesh is a luminous object light source. The target light source type is a light source type of current light source sampling. There may be one or more light source types in each light source sampling. In other words, the target light source type may include one or more candidate light source types.

For example, sunlight is directional light, a light bulb is a point light source, a flashlight is a spotlight, and a rectangular lamp is a rectangular surface light source. The luminous object light source may include at least one of a billboard, a light strip, and the like in the virtual scene.

In an embodiment, the terminal may determine the target point from the virtual scene. It is to be understood that to perform lighting rendering on the target point, a plurality of light source samplings need to be performed on the target point. In other words, some light sources are sampled from the virtual scene to perform lighting rendering on the target point. For the target point in the virtual scene, the terminal may determine a target light source type of current light source sampling among a plurality of candidate light source types corresponding to the virtual scene in each light source sampling performed on the target point. In an embodiment, this application may provide a plurality of light source sampling modes. A user may select one of the plurality of light source sampling modes as a light source sampling mode corresponding to the virtual scene. For the target point in the virtual scene, the terminal may determine, based on the light source sampling mode corresponding to the virtual scene, a target light source type of current light source sampling among a plurality of candidate light source types corresponding to the virtual scene in each light source sampling performed on the target point.

Step 204: Perform light source sampling on the target point to obtain a target light source that matches the target light source type.

In an embodiment, the terminal may perform light source sampling on the target point to obtain a target light source corresponding to current light source sampling and matching the target light source type.

In an embodiment, the target light source type includes at least one of the virtual light source type and the luminous object light source type.

The target light source is a light source sampled in the current light source sampling from the virtual scene. It is to be understood that because the target light source type may include at least one of the virtual light source type and the luminous object light source type, the target light source may include at least one of the virtual light source and the luminous object light source.

Specifically, each light source type corresponds to a particular light source sampling manner. Because the target light source type may include one or more candidate light source types, for each light source type in the target light source type, the terminal may sample, in a light source sampling manner corresponding to the light source type, a light source that matches the light source type from the virtual scene to obtain the target light source of the current light source sampling.

In an embodiment, when the target light source type includes the virtual light source type, the terminal may sample, in a light source sampling manner corresponding to the virtual light source type, a light source that matches the virtual light source type from the virtual scene to obtain the target light source of the current light source sampling.

In an embodiment, when the target light source type includes the luminous object light source type, the terminal may sample, in a light source sampling manner corresponding to the luminous object light source type, a light source that matches the luminous object light source type from the virtual scene to obtain the target light source of the current light source sampling.

Step 206: Render the target point based on the target light source.

In an embodiment, after a plurality of light source samplings are performed on the target point, the target point is rendered based on target light sources obtained by respective light source samplings.

In an embodiment, for each of a plurality of target light sources obtained by a plurality of light source samplings, the terminal may randomly sample a light source point from the target light source. Further, the terminal may perform lighting rendering on the target point based on light source points respectively corresponding to the plurality of target light sources. The light source point is a point in the target light source. Light source point sampling is performed on the target light source, and lighting rendering is performed on the target point based on sampled light source points to improve rendering efficiency for the target point, thereby improving image rendering efficiency.

In an embodiment, the light source sampling refers to determining a target light source for rendering the target point among a plurality of light sources. It is to be understood that a result obtained from the light source sampling is a target light source. After the target light source is determined, the terminal may determine a color of emergent light of the target point based on the emissive light color of the light source point of each target light source, a material parameter corresponding to a surface material of the target point, a direction vector of incident light, and a surface normal vector of the target point. Further, the terminal may perform lighting rendering on the target point based on the color of the emergent light. The incident light refers to light rays that reach the target point, and the emergent light refers to light rays that emit from the target point. It is to be understood that the emergent light is light rays that enter eyes of the user. In this embodiment, the emissive light color of the target light source, the surface material of the target point, the direction vector of the incident light, and the surface normal vector of the target point are comprehensively considered to accurately determine lighting contribution of each target light source to the target point and improve a lighting rendering effect for the target point, thereby improving quality of a final rendered image.

In an embodiment, that the terminal performs lighting rendering on the target point may be implemented by the following rendering equation:

$$\\ L ( x , {ω}_{o} ) = {\int }_{Ω} {L}_{i} ( x , {ω}_{i} ) f ( x , {ω}_{i} , {ω}_{o} ) ( {ω}_{i} \cdot {ω}_{n} ) d {ω}_{i}$$

x represents a target point. ωᵢ represents a direction vector of incident light. ωₒ represents a direction vector of emergent light. ωₙ represents a surface normal vector of the target point x. Ω represents a set of all incident lights. f is a bidirectional reflectance distribution function. It is to be understood that f(x,ωᵢ,ωₒ) represents the material parameter corresponding to the surface material of the target point x. Lᵢ(x,ωᵢ) represents the color of the incident light, that is, the emissive light color of the target light source. L(x,ωₒ) represents the color of the emergent light.

In an embodiment, that the terminal performs lighting rendering on the target point may alternatively be implemented by the following rendering equation:

$$\\ L ( x , {ω}_{o} ) = {\int }_{{Ω}_{direct}} {L}_{direct} ( x , {ω}_{direct} ) f ( x , {ω}_{direct} , {ω}_{o} ) ( {ω}_{direct} \cdot {ω}_{n} ) d {ω}_{direct} + {\int }_{{Ω}_{brdf}} {L}_{indirect} ( x , {ω}_{indirect} ) f ( x , {ω}_{indirect} , {ω}_{o} ) ( {ω}_{indirect} \cdot {ω}_{n} ) d {ω}_{indirect}$$

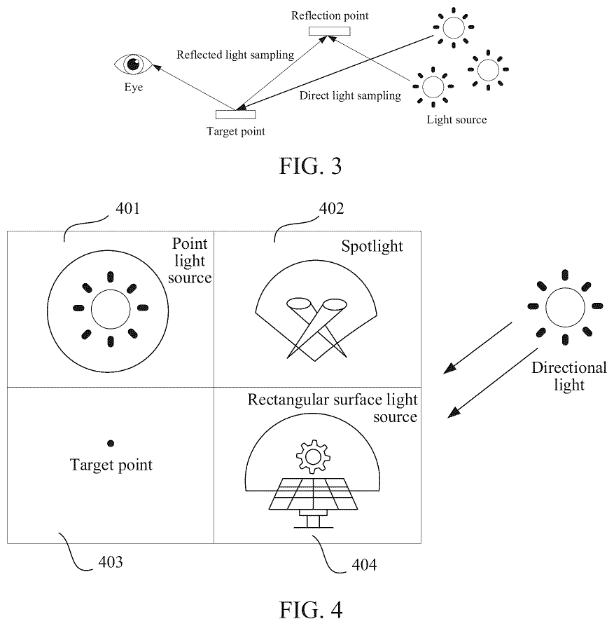

ω_{direct} represents a direction vector of direct incident light. ω_{indirect} represents a direction vector of reflected incident light. Ω_{direct} represents a set of all direct incident light. Ω_{brdf} represents a set of all reflected incident light. L_{direct} (x, ω_{direct}) direct represents the color of the direct incident light. L_{indirect} (x, ω_{indirect}) represents the color of the reflected incident light. It is to be understood that both direct incident light and reflected incident light are incident light. As shown in FIG. 3, the direct incident light is for representing light rays emitted by the target light source directly reaching the target point. The reflected incident light is for representing light emitted by the target light source being reflected by an object in the virtual scene and then reaching the target point. Light rays that are finally reflected by the target point and enter the eyes of the user are L(x, ωₒ), that is, a color that the target point is rendered.

In the virtual scene rendering method, for the target point in the virtual scene, the target light source type of the current light source sampling among the plurality of candidate light source types is determined in each light source sampling performed on the target point. Light source sampling is performed on the target point to obtain the target light source corresponding to the current light source sampling and matching the target light source type. In each light source sampling, the target light source type of the current light source sampling is determined among the plurality of candidate light source types, and the target light source that matches the target light source type is sampled from the plurality of candidate light source types. Therefore, there is a high probability that light sources obtained by a plurality of light source samplings on the target point include light sources corresponding to a plurality of candidate light source types, thereby avoiding singularity of light source types. In this way, after a plurality of light source samplings are performed on the target point, the target point is rendered based on target light sources obtained by respective light source samplings to improve the rendering effect of the target point, thereby improve rendering quality of an image.

In an embodiment, the determining the target light source type of the current light source sampling among the plurality of candidate light source types includes: determining a light source sampling mode corresponding to the virtual scene; selecting a corresponding subset of the plurality of candidate light source types as the target light source type of the current light source sampling when the light source sampling mode is a first sampling mode; and using the plurality of candidate light source types as target light source types of the current light source sampling when the light source sampling mode is a second sampling mode.

The first sampling mode is a light source sampling mode used for indicating selecting a corresponding subset of the plurality of candidate light source types corresponding to the virtual scene. The second sampling mode is a light source sampling mode used for indicating selecting various light source types corresponding to the virtual scene. It is to be understood that the first sampling mode is partial sampling for light source types, and the second sampling mode is full sampling for the light source types.

Specifically, the terminal may provide a plurality of light source sampling modes for light source sampling. The user may select one of the plurality of light source sampling modes to sample light sources in a virtual scene. The terminal may determine the light source sampling mode selected by the user as a light source sampling mode corresponding to the virtual scene. The terminal may select a corresponding subset of the plurality of candidate light source types corresponding to the virtual scene as the target light source type of the current light source sampling when the light source sampling mode is the first sampling mode. The terminal may directly use the plurality of candidate light source types corresponding to the virtual scene as target light source types of the current light source sampling when the light source sampling mode is the second sampling mode. For example, the plurality of candidate light source types corresponding to the virtual scene include the virtual light source type and the luminous object light source type. The terminal may directly use the virtual light source type and the luminous object light source type as the target light source types of the current light source sampling.

In an embodiment, the terminal may randomly select a corresponding subset of the plurality of candidate light source types corresponding to the virtual scene as the target light source type of the current light source sampling directly when the light source sampling mode is the first sampling mode. For example, the plurality of candidate light source types corresponding to the virtual scene include the virtual light source type and the luminous object light source type. The terminal may randomly select one of the virtual light source type and the luminous object light source type as the target light source type of the current light source sampling directly.

In the foregoing embodiment, a corresponding subset of the plurality of candidate light source types is selected as the target light source type when the light source sampling mode is the first sampling mode. In this way, rendering efficiency of an image can be ensured while improving the rendering quality of the image. This is very suitable for real-time rendering of an image. The plurality of candidate light source types are used as the target light source types of the current light source sampling when the light source sampling mode is the second sampling mode. In this way, the rendering quality of an image can be further improved. This is very suitable for a scene with a high requirement on image quality.

In an embodiment, the selecting a corresponding subset of the plurality of candidate light source types as the target light source type of the current light source sampling when the light source sampling mode is a first sampling mode includes: determining total luminous flux of each of the plurality of candidate light source types when the light source sampling mode is the first sampling mode; obtaining a type sampling random number for the current light source sampling; and determining the target light source type of the current light source sampling among the plurality of candidate light source types based on the type sampling random number and the total luminous flux of each light source type.

The total luminous flux is a sum of luminous flux of all light sources corresponding to each light source type. The type sampling random number is a random number used for determining a target light source type among a plurality of candidate light source types in each light source sampling.

Specifically, when the light source sampling mode is the first sampling mode, for each light source type, the terminal may calculate luminous flux of each light source that matches the light source type. The terminal may add together the luminous flux of all light sources of the light source type to obtain the total luminous flux of the light source type. The terminal may obtain the type sampling random number for the current light source sampling, and determine the target light source type of the current light source sampling among the plurality of candidate light source types based on the type sampling random number and the total luminous flux of each light source type.

In an embodiment, the terminal may determine, based on the total luminous flux of each light source type, a sampling weight range corresponding to each light source type. The total luminous flux is positively correlated with the sampling weight range. In each time light source sampling, a sampling weight range of a specific light source type within which the type sampling random number falls is determined. The terminal may determine, as the target light source type, the light source type corresponding to the sampling weight range within which the type sampling random number falls. It is to be understood that a light source type having higher total luminous flux corresponds to a larger sampling weight range and a higher probability that the type sampling random number falls within the sampling weight range of the light source type. In other words, a light source type having higher total luminous flux has a higher probability of being determined as a target light source type, and a light source type having lower total luminous flux has a lower probability of being determined as a target light source type. The light source type corresponding to the sampling weight range within which the type sampling random number falls is determined as the target light source type of light source sampling, and a better light source type may be selected among the plurality of candidate light source types to further improve the rendering effect of the target point, thereby further improving the rendering quality of an image.

In the foregoing embodiment, the target light source type is determined among the plurality of candidate light source types based on the type sampling random number and the total luminous flux of each light source type. The light source type having higher total luminous flux has a higher probability of being determined as the target light source type. In this way, the rendering effect of the target point can be further improved, thereby further improving the rendering quality of an image.

In an embodiment, the performing light source sampling on the target point to obtain a target light source corresponding to current light source sampling and matching the target light source type includes: determining, when the target light source type includes a virtual light source type, a target spatial grid to which the target point belongs among candidate spatial grids pre-constructed for virtual light sources, the virtual light sources being light sources in the virtual scene that match the virtual light source type; and sampling virtual light sources in the target spatial grid to obtain the target light source corresponding to the current light source sampling and matching the target light source type.

In an embodiment, when the target light source type includes the virtual light source type, the terminal may determine, based on world space coordinates of the target point, the target spatial grid to which the target point belongs among the candidate spatial grids pre-constructed for the virtual light sources. It is to be understood that the terminal may find an intersection between the world space coordinates of the target point and world space coordinates of each candidate spatial grid, and use a candidate spatial grid that intersects the world space coordinates of the target point as the target spatial grid to which the target point belongs. Further, the terminal may sample virtual light sources in the target spatial grid to obtain the target light source of the current light source sampling.

In an embodiment, as shown in FIG. 4, the virtual light sources includes a point light source, a spotlight, a rectangular surface light source, and directional light. The influence range of the directional light is infinite, so that light rays emitted by the directional light can influence each candidate spatial grid. 401 to 404 in FIG. 4 are candidate spatial grids respectively pre-constructed for the virtual light sources. The point light source and the directional light influence the candidate spatial grid 401. The spotlight and the directional light influence the candidate spatial grid 402. The directional light influences the candidate spatial grid 403. The rectangular surface light source and the directional light influence the candidate spatial grid 404. It can be learned from FIG. 4 that a candidate spatial grid to which the target point belongs is 403. In other words, the candidate spatial grid 403 is the target spatial grid. It can further be learned from FIG. 4 that the virtual light source that influences the target spatial grid 403 is only the directional light. Therefore, the directional light in the target spatial grid 403 is sampled to obtain the target light source of the current light source sampling.

In an embodiment, the terminal may determine whether a quantity of virtual light sources in the target spatial grid satisfies a light source denseness condition or a light source sparseness condition. When the quantity of virtual light sources in the target spatial grid satisfies the light source denseness condition, the terminal may sample the virtual light sources in the target spatial grid in a light source sampling manner corresponding to the light source denseness condition to obtain the target light source of the current light source sampling. When the quantity of virtual light sources in the target spatial grid satisfies the light source sparseness condition, the terminal may sample the virtual light sources in the target spatial grid in a light source sampling manner corresponding to the light source sparseness condition to obtain the target light source of the current light source sampling.

In an embodiment, the light source denseness condition may be that the quantity of virtual light sources in the target spatial grid is greater than or equal to a preset quantity of light sources, or may be that the quantity of virtual light sources in the target spatial grid falls within a preset first light source quantity range. The light source sparseness condition may be that the quantity of virtual light sources in the target spatial grid is less than the preset quantity of light sources, or may be that the quantity of virtual light sources in the target spatial grid falls within a preset second light source quantity range. A numerical value corresponding to the first light source quantity range is greater than a numerical value corresponding to the second light source quantity range.

In the foregoing embodiment, the target spatial grid to which the target point belongs is determined among the candidate spatial grids pre-constructed for the virtual light sources. Because virtual light sources that make great lighting contribution to the target point have a high probability of falling within the target spatial grid, the target light source corresponding to the current light source sampling and matching the target light source type can be quickly obtained by sampling the virtual light sources in the target spatial grid, thereby improving efficiency of sampling the virtual light sources.

In an embodiment, the sampling virtual light sources in the target spatial grid to obtain the target light source corresponding to the current light source sampling and matching the target light source type includes: sampling, when the quantity of virtual light sources in the target spatial grid satisfies the light source denseness condition, the virtual light sources in the target spatial grid based on a virtual light source bounding volume hierarchy pre-constructed for the virtual light sources in the target spatial grid to obtain the target light source corresponding to the current light source sampling and matching the target light source type, a node in the virtual light source bounding volume hierarchy being used for recording the virtual light sources in the target spatial grid.

The virtual light source bounding volume hierarchy is a light source bounding volume hierarchy pre-constructed for the virtual light sources in the target spatial grid. It is to be understood that the virtual light source bounding volume hierarchy is a tree-like data storage structure. The virtual light source bounding volume hierarchy includes a plurality of nodes, and each node is used for recording the virtual light sources in the target spatial grid.

Specifically, when the quantity of virtual light sources in the target spatial grid satisfies the light source denseness condition, the terminal may sample the virtual light sources in the target spatial grid in the light source sampling manner corresponding to the light source denseness condition. In other words, the terminal can obtain the virtual light source bounding volume hierarchy pre-constructed for the virtual light sources in the target spatial grid, and sample the virtual light sources in the target spatial grid based on the virtual light source bounding volume hierarchy pre-constructed for the virtual light sources in the target spatial grid to obtain the target light source of the current light source sampling.

In the foregoing embodiment, when the quantity of virtual light sources in the target spatial grid satisfies the light source denseness condition, which indicates that the quantity of virtual light sources in the target spatial grid is large, the virtual light sources in the target spatial grid are sampled based on the virtual light source bounding volume hierarchy pre-constructed for the virtual light sources in the target spatial grid to obtain the target light source corresponding to the current light source sampling and matching the target light source type. In this way, the efficiency of sampling the virtual light sources can be improved.

In an embodiment, the sampling virtual light sources in the target spatial grid to obtain the target light source corresponding to the current light source sampling and matching the target light source type includes: determining first irradiance of each virtual light source in the target spatial grid for the target point when the quantity of virtual light sources in the target spatial grid satisfies the light source sparseness condition; obtaining a virtual light source sampling random number; and sampling the virtual light sources in the target spatial grid based on the virtual light source sampling random number and the first irradiance to obtain the target light source corresponding to the current light source sampling and matching the target light source type.

The first irradiance is irradiance of each virtual light source in the target spatial grid for the target point. The virtual light source sampling random number is a random number used for sampling the virtual light sources in the target spatial grid.

Specifically, the terminal may determine the first irradiance of each virtual light source in the target spatial grid for the target point when the quantity of virtual light sources in the target spatial grid satisfies the light source sparseness condition. The terminal may obtain the virtual light source sampling random number for the current light source sampling, and sample the virtual light sources in the target spatial grid based on the virtual light source sampling random number and the first irradiance to obtain the target light source of the current light source sampling.

In an embodiment, the terminal may determine, based on the first irradiance of each virtual light source in the target spatial grid for the target point, a sampling weight range corresponding to each virtual light source. In each light source sampling, a sampling weight range of a specific virtual light source within which the virtual light source sampling random number falls is determined. The terminal may determine, as the target light source of the current light source sampling, the virtual light source corresponding to the sampling weight range within which the virtual light source sampling random number falls. It is to be understood that a virtual light source having higher first irradiance corresponds to a larger sampling weight range and a higher probability that the virtual light source sampling random number falls within the sampling weight range of the light source type. In other words, a virtual light source having higher first irradiance has a higher probability of being determined as the target light source, and a virtual light source having lower first irradiance has a lower probability of being determined as the target light source.

In an embodiment, for each virtual light source in the target spatial grid, the terminal may determine the first irradiance of each virtual light source in the target spatial grid for the target point based on luminous flux and orientation of the virtual light source, a relative position of the target point and the virtual light source, and a distance between the target point and the virtual light source.

In the foregoing embodiment, when the quantity of virtual light sources in the target spatial grid satisfies the light source sparseness condition, which indicates that the quantity of virtual light sources in the target spatial grid is small, the virtual light sources in the target spatial grid are directly sampled based on the virtual light source sampling random number and the first irradiance corresponding to each virtual light source. In this way, the efficiency of sampling the virtual light sources can be improved. In addition, because the virtual light source having higher first irradiance has a higher probability of being sampled, the rendering quality of an image can be further improved.

In an embodiment, the terminal may use space where the virtual scene is located as a to-be-partitioned spatial bounding volume, and perform spatial grid partitioning on the spatial bounding volume to obtain candidate spatial grids for the virtual light sources.

In an embodiment, the method further includes: determining, for each virtual light source in the virtual scene, a lighting influence range of the virtual light source based on a lighting influence radius and a lighting influence angle of the virtual light source; constructing a first spatial bounding volume based on the lighting influence range of each virtual light source in the virtual scene, the first spatial bounding volume enclosing lighting influence ranges of all the virtual light sources in the virtual scene; and performing spatial grid partitioning on the first spatial bounding volume to obtain candidate spatial grids for the virtual light source, in each candidate spatial grid, a light source identifier of a virtual light source that influences the candidate spatial grid being recorded.

The lighting influence radius is a distance that light rays emitted by the virtual light source can reach. The lighting influence angle is a union of directions of the light rays emitted by the virtual light source. The lighting influence range is a range that the light rays emitted by the virtual light source can influence. It is to be understood that only when the target point is within the lighting influence range of the virtual light source, the virtual light source makes lighting contribution to the target point. If the target point is outside the lighting influence range of the virtual light source, the virtual light source makes no lighting contribution to the target point. The first spatial bounding volume is a spatial bounding volume constructed based on the lighting influence range of each virtual light source in the virtual scene.

Specifically, for each virtual light source in the virtual scene, the terminal may obtain the lighting influence radius and the lighting influence angle of the virtual light source, and determine the lighting influence range of the virtual light source based on the lighting influence radius and the lighting influence angle of the virtual light source. The terminal may construct the first spatial bounding volume based on the lighting influence range of each virtual light source in the virtual scene. The terminal may perform spatial grid partitioning on the first spatial bounding volume to obtain the candidate spatial grids for the virtual light source. In each candidate spatial grid, a light source identifier of a virtual light source that influences the candidate spatial grid is recorded.

In an embodiment, the shape of the first spatial bounding volume is a cuboid. The terminal may select two sides having the longest side length and perpendicular to each other of the first spatial bounding volume to perform spatial grid partitioning on the first spatial bounding volume to obtain the candidate spatial grids for the virtual light source. In this way, disparity in side length ratios of sides of the candidate spatial grids obtained by partitioning can be avoid, thereby making the candidate spatial grids obtained by partitioning more reasonable.

In an embodiment, the terminal may perform spatial grid partitioning on the first spatial bounding volume to obtain initial spatial grids. Further, the terminal may find an intersection between the lighting influence range of each virtual light source and each initial spatial grid. For each initial spatial grid, the terminal may determine virtual light sources corresponding to lighting influence ranges that intersect with the initial spatial grids as virtual light sources that have lighting influence on the initial spatial grids, and record identifiers of the virtual light sources in the initial spatial grids to obtain the candidate spatial grids.

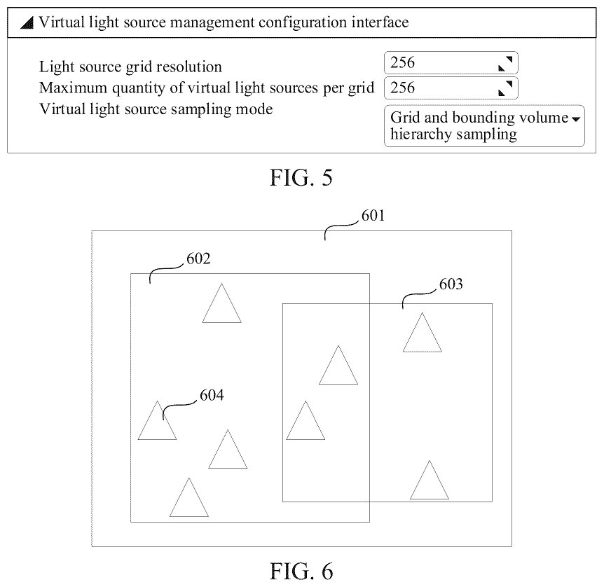

In an embodiment, as shown in FIG. 5, the terminal may provide a configuration interface for virtual light sources. Resolution for light source grid partitioning, a maximum quantity of virtual light sources in each grid, and a virtual light source sampling mode may be set separately on the configuration interface. It is to be understood that the terminal may perform partitioning based on the set resolution to obtain candidate spatial grids. A quantity of virtual light sources in the candidate spatial grids obtained by partitioning does not exceed the set maximum quantity of virtual light sources. The set virtual light source sampling mode represents that virtual light sources in a virtual scene can be sampled via grids and a light source bounding volume hierarchy.

In the foregoing embodiment, the first spatial bounding volume is constructed based on the lighting influence range of each virtual light source in the virtual scene to make the constructed first spatial bounding volume more suitable for each virtual light source in the virtual scene, that is, to avoid extremely large space of the constructed first spatial bounding volume. Spatial grid partitioning is performed on the first spatial bounding volume to obtain candidate spatial grids for the virtual light source, so that rationality of the candidate spatial grids is improved, thereby further improving the rendering quality of an image.

In an embodiment, the performing light source sampling on the target point to obtain a target light source corresponding to current light source sampling and matching the target light source type includes: sampling, when the target light source type includes a luminous object light source type, luminous object light sources in the virtual scene based on a luminous object light source bounding volume hierarchy pre-constructed for the luminous object light sources to obtain the target light source corresponding to the current light source sampling and matching the target light source type, the luminous object light sources being light sources in the virtual scene that match the luminous object light source type, and a node in the luminous object light source bounding volume hierarchy being used for recording the luminous object light sources in the virtual scene.

The luminous object light source bounding volume hierarchy is a light source bounding volume hierarchy pre-constructed for the luminous object light sources in the virtual scene. It is to be understood that the luminous object light source bounding volume hierarchy is a tree-like data storage structure. The luminous object light source bounding volume hierarchy includes a plurality of nodes, and each node is used for recording the luminous object light sources in the virtual scene.

Specifically, when the target light source type includes the luminous object light source type, the terminal may obtain the luminous object light source bounding volume hierarchy pre-constructed for the luminous object light sources, and sample the luminous object light sources in the virtual scene based on the luminous object light source bounding volume hierarchy pre-constructed for the luminous object light sources to obtain the target light source of the current light source sampling.

In an embodiment, as shown in FIGS. 6, 601, 602, and 603 in FIG. 6 represent nodes in the luminous object light source bounding volume hierarchy, and 604 in FIG. 6 represents the luminous object light source in the virtual scene. It is to be understood that 601 is a root node of the luminous object light source bounding volume hierarchy, and 602 and 603 are a left sub-node and a right sub-node under the root node 601.

In the foregoing embodiment, when the target light source type includes the luminous object light source type, because a quantity of luminous object light sources corresponding to the luminous object light source type is large, the luminous object light sources in the virtual scene are sampled based on the luminous object light source bounding volume hierarchy pre-constructed for the luminous object light sources to obtain the target light source corresponding to current light source sampling and matching the target light source type. In this way, efficiency of sampling the luminous object light sources can be improved.

In an embodiment, the performing light source sampling on the target point to obtain a target light source corresponding to current light source sampling and matching the target light source type includes: determining a light source bounding volume hierarchy pre-constructed for the target light source type, a node in the light source bounding volume hierarchy being used for recording light sources in the virtual scene that match the target light source type; using a root node of the light source bounding volume hierarchy as a target node of current-round node sampling, and determining a node sampling weight of each sub-node under the target node to the target point; obtaining a node sampling random number for the current-round node sampling; determining a sampled node of the current-round node sampling among sub-nodes under the target node based on the node sampling random number and the node sampling weight; and using the sampled node as the target node of the current-round node sampling, considering next-round node sampling as the current-round node sampling, iteratively performing the operation of determining a node sampling weight of each sub-node under the target node to the target point until a node sampling iteration stop condition is satisfied, and sampling light sources that are in a sampled node determined in a final round and that match the target light source type to obtain the target light source of the current light source sampling.

The node sampling weight is used for determining a weight of the sampled node among the sub-nodes under the target node. The node sampling random number is used for determining a random number of the sampled node among the sub-nodes under the target node. The sampled node is a sub-node sampled from the sub-nodes under the target node. It is to be understood that the light source bounding volume hierarchy includes the foregoing virtual light source bounding volume hierarchy and the foregoing luminous object light source bounding volume hierarchy.

In an embodiment, the node sampling iteration stop condition may be that the sampled node obtained by sampling is a leaf node of the light source bounding volume hierarchy, or a quantity of node sampling iterations reaches a preset quantity of node samplings.

Specifically, the terminal may determine the light source bounding volume hierarchy pre-constructed for the target light source type, and use the root node of the light source bounding volume hierarchy as the target node of the current-round node sampling. The terminal may determine the node sampling weight of each sub-node under the target node to the target point. The terminal may obtain the node sampling random number for the current-round node sampling, and determine the sampled node of the current-round node sampling among the sub-nodes under the target node based on the node sampling random number and the node sampling weight. Further, the terminal may use the sampled node as the target node of the current-round node sampling, consider the next-round node sampling as the current-round node sampling, iteratively perform the operation of determining a node sampling weight of each sub-node under the target node to the target point until the node sampling iteration stop condition is satisfied, and sample light sources that are in the sampled node determined in the final round and that match the target light source type to obtain the target light source of the current light source sampling.

In an embodiment, the terminal may determine, based on the node sampling weight of each sub-node under the target node to the target point, a sampling weight range corresponding to each sub-node. In each node sampling, a sampling weight range of a specific sub-node within which the node sampling random number falls is determined. The terminal may determine, as the sampled node of the current node sampling, the sub-node corresponding to the sampling weight range within which the node sampling random number falls. It is to be understood that a sub-node having a greater node sampling weight corresponds to a larger sampling weight range and a higher probability that the node sampling random number falls within the sampling weight range of the sub-node. In other words, a sub-node having a higher node sampling weight has a higher probability of being determined as the sampled node, and a sub-node having a lower node sampling weight has a lower probability of being determined as the sampled node.

In an embodiment, when the light source bounding volume hierarchy is the foregoing virtual light source bounding volume hierarchy, the terminal may use a root node of the virtual light source bounding volume hierarchy as the target node of the current-round node sampling. The terminal may determine the node sampling weight of each sub-node under the target node to the target point. The terminal may obtain the node sampling random number for the current-round node sampling, and determine the sampled node of the current-round node sampling among the sub-nodes under the target node based on the node sampling random number and the node sampling weight. Further, the terminal may use the sampled node as the target node of the current-round node sampling, consider the next-round node sampling as the current-round node sampling, iteratively perform the operation of determining a node sampling weight of each sub-node under the target node to the target point until the node sampling iteration stop condition is satisfied, and sample virtual light sources in the sampled node determined in the final round to obtain the target light source of the current light source sampling.

In an embodiment, when the light source bounding volume hierarchy is the foregoing luminous object light source bounding volume hierarchy, the terminal may use a root node of the luminous object light source bounding volume hierarchy as the target node of the current-round node sampling. The terminal may determine the node sampling weight of each sub-node under the target node to the target point. The terminal may obtain the node sampling random number for the current-round node sampling, and determine the sampled node of the current-round node sampling among the sub-nodes under the target node based on the node sampling random number and the node sampling weight. Further, the terminal may use the sampled node as the target node of the current-round node sampling, consider the next-round node sampling as the current-round node sampling, iteratively perform the operation of determining a node sampling weight of each sub-node under the target node to the target point until the node sampling iteration stop condition is satisfied, and sample luminous object light sources in the sampled node determined in the final round to obtain the target light source of the current light source sampling.

In an embodiment, the terminal may determine the node sampling weight of each sub-node under the target node to the target point based on luminous flux of light sources that are in each sub-node under the target node and that match the target light source type. It is to be understood that for each sub-node, a sub-node having higher corresponding luminous flux has a greater node sampling weight to the target point.

In an embodiment, the terminal may sample the light sources that are in the sampled node determined in the final round and that match the target light source type to obtain the target light source of the current light source sampling. It is to be understood that the terminal may randomly select a light source among the light sources that are in the sampled node determined in the final round and that match the target light source type as the target light source of the current light source sampling.

In the foregoing embodiment, the root node of the light source bounding volume hierarchy is used as the target node of the current-round node sampling, the node sampling weight of each sub-node under the target node to the target point is determined, and the sampled node of the current-round node sampling is determined among the sub-nodes under the target node based on the node sampling random number and the node sampling weight. It is to be understood that the sub-node having a higher node sampling weight has a higher probability of being sampled. The sampled node is used as a target node of a new-round node sampling, the node sampling process is iterated, and the light sources that are in the sampled node determined in the final round and that match the target light source type are sampled, to obtain the target light source of the current light source sampling. In this way, light source sampling accuracy can be further improved while ensuring light source sampling efficiency, thereby further improving the rendering quality of an image.

In an embodiment, the determining a node sampling weight of each sub-node under the target node to the target point includes: for each sub-node under the target node, determining, based on luminous flux of each light source in the sub-node, node luminous flux corresponding to the sub-node; determining, based on a relative position of the sub-node and the target point, a node orientation parameter corresponding to the sub-node; and determining the node sampling weight of the sub-node to the target point based on the node luminous flux, the node orientation parameter, and a distance between the sub-node and the target point.

The node luminous flux is a sum of luminous flux of light sources in the sub-node. The node orientation parameter is used for representing orientation of a sub-node relative to the target point.

Specifically, for each sub-node under the target node, the terminal may calculate the luminous flux of each light source in the sub-node, and determine, based on the luminous flux of each light source in the sub-node, the node luminous flux corresponding to the sub-node. The terminal may determine, based on the relative position of the sub-node and the target point, the node orientation parameter corresponding to the sub-node. Further, the terminal may determine the node sampling weight of the sub-node to the target point based on the node luminous flux, the node orientation parameter, and the distance between the sub-node and the target point.

In an embodiment, the node sampling weight of the sub-node to the target point can be calculated by the following formula:

$$\\ impor tan ce ( X , C ) = \frac{Φ ( C ) \vert cos {θ}_{i}^{{}_{} ′} \vert}{{‖ X - C ‖}^{2}} \times \{ \begin{matrix}cos {θ}^{{}_{} ′} , {θ}^{{}_{} ′} < {θ}_{e} \\ 0 , {θ}^{{}_{} ′} \geq {θ}_{e}\end{matrix} ;$$

$$\\ {θ}_{i}^{{}_{} ′} = max ( 0 , {θ}_{i} - {θ}_{u} ) ; {θ}^{{}_{} ′} = max ( 0 , θ - {θ}_{o} - {θ}_{u} )$$

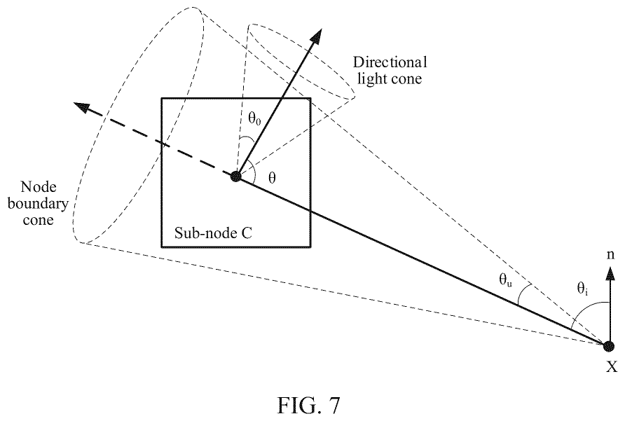

As shown in FIG. 7, X represents the target point. C represents the sub-node. Φ(C) represents the node luminous flux corresponding to the sub-node. θᵤ represents an angle between a conical axis of a node boundary cone and a generatrix of the node boundary cone. θᵢ represents an angle between the conical axis of the node boundary cone and a surface normal vector n of the target point. θₒ represents an angle between a conical axis of a directional light cone and a generatrix of the directional light cone. θ represents an angle between the conical axis of the node boundary cone and the conical axis of the directional light cone. θₑ represents a preset angle. importance(X,C) represents the node sampling weight of the sub-node C to the target point X. The node boundary cone refers to a cone formed by a tangent between rays emitted by the target point X and a boundary of the sub-node C. The directional light cone refers to a cone formed by light rays emitted by all light sources in the sub-node C.

In the foregoing embodiment, the node sampling weight of the sub-node to the target point is determined based on the node luminous flux, the node orientation parameter, and the distance between the sub-node and the target point, so that accuracy of the node sampling weight can be improved, thereby improving sampling accuracy for nodes.

In an embodiment, the sampling light sources that are in a sampled node determined in a final round and that match the target light source type to obtain the target light source of the current light source sampling includes: calculating second irradiance of each light source that is in the sampled node determined in the final round and that matches the target light source type for the target point; obtaining a light source sampling random number for the current light source sampling; and sampling, based on the light source sampling random number and the second irradiance, the light sources that are in the sampled node determined in the final round and that match the target light source type to obtain the target light source of the current light source sampling.

The second irradiance is irradiance of each light source that is in the sampled node determined in the final round and that matches the target light source type for the target point. The light source sampling random number is a random number used for sampling the light sources that are in the sampled node determined in the final round and that match the target light source type.

Specifically, the terminal may calculate the second irradiance of each light source that is in the sampled node determined in the final round and that matches the target light source type for the target point, and obtain the light source sampling random number for the current light source sampling. Further, the terminal may sample, based on the light source sampling random number and the second irradiance, the light sources that are in the sampled node determined in the final round and that match the target light source type to obtain the target light source of the current light source sampling.

In an embodiment, the terminal may determine, based on the second irradiance of each light source that is in the sampled node determined in the final round and that matches the target light source type for the target point, a sampling weight range corresponding to each light source. In each time light source sampling, a sampling weight range of a specific light source within which the light source sampling random number falls is determined. The terminal may determine, as the target light source of the current light source sampling, the light source corresponding to the sampling weight range within which the light source sampling random number falls. It is to be understood that a light source having greater second irradiance corresponds to a larger sampling weight range and a higher probability that the light source sampling random number falls within the sampling weight range of the light source type. In other words, a light source having higher second irradiance has a higher probability of being determined as the target light source, and a light source having lower second irradiance has a lower probability of being determined as the target light source.

In an embodiment, for each light source that is in the sampled node determined in the final round and that matches the target light source type, the terminal may determine, based on luminous flux and orientation of the light source, a relative position of the target point and the virtual light source, and a distance between the target point and the light source, the second irradiance of each light source that is in the sampled node determined in the final round and matching the target light source type for the target point.

In the foregoing embodiment, the light sources that are in the sampled node determined in the final round and that match the target light source type are sampled based on the light source sampling random number and the second irradiance of each light source to obtain the target light source of the current light source sampling. The light source having higher second irradiance has a higher probability of being sampled. Therefore, the light source sampling accuracy can be improved, thereby further improving the rendering quality of an image.

In an embodiment, the target light source of the current light source sampling is obtained by sampling based on the light source bounding volume hierarchy pre-constructed for the target light source type. The method further includes: constructing a second spatial bounding volume based on volumes of light sources in the virtual scene that match a same light source type, the second spatial bounding volume enclosing the light sources that match the same light source type; using the second spatial bounding volume as a target bounding volume in current-round partitioning, and determining a partitioning plane for the target bounding volume in the current-round partitioning; partitioning the target bounding volume into a left bounding volume and a right bounding volume based on the partitioning plane; and using the left bounding volume and the right bounding volume separately as the target bounding volume in the current-round partitioning, considering next-round partitioning as the current-round partitioning, and iteratively performing the operation of determining a partitioning plane for the target bounding volume in the current-round partitioning until a partitioning iteration stop condition is satisfied to obtain the light source bounding volume hierarchy.

The second spatial bounding volume is a spatial bounding volume constructed based on the volumes of the light sources in the virtual scene that match the same light source type. The partitioning plane is a plane used for performing bounding volume partitioning on the target bounding volume. The left bounding volume is a sub-bounding volume located at the left of the target bounding volume and under the target bounding volume. The right bounding volume is a sub-bounding volume located at the right of the target bounding volume and under the target bounding volume. It is to be understood that if the target bounding volume is regarded as a node, the left bounding volume and the right bounding volume are a left sub-node and a right sub-node under the node.

Specifically, the terminal may construct the second spatial bounding volume based on the volumes of the light sources in the virtual scene that match the same light source type, and use the second spatial bounding volume as the target bounding volume in the current-round partitioning. The terminal may determine the partitioning plane for the target bounding volume in the current-round partitioning, and partition the target bounding volume into the left bounding volume and the right bounding volume based on the partitioning plane. Further, the terminal may use the left bounding volume and the right bounding volume separately as the target bounding volume in the current-round partitioning, use next-round partitioning as the current-round partitioning, and iteratively perform the operation of determining a partitioning plane for the target bounding volume in the current-round partitioning until the partitioning iteration stop condition is satisfied to obtain the light source bounding volume hierarchy.

In an embodiment, the partitioning iteration stop condition may be that a quantity of plane partitionings reaches a preset quantity of plane partitionings, or may be that a quantity of light sources that are in the target bounding volume obtained by partitioning and that match the same light source type reaches a preset quantity of light sources.

In an embodiment, for each of a plurality of candidate partitioning planes preset for the current-round partitioning, the terminal may partition the target bounding volume into a candidate left bounding volume and a candidate right bounding volume based on the candidate partitioning plane, and determine a quantity of light sources in the candidate left bounding volume and a quantity of light sources in the candidate right bounding volume separately. The terminal may use, as the partitioning plane for the target bounding volume in the current-round partitioning, a candidate partitioning plane that enables the quantity of light sources in the candidate left bounding volume to be closest to the quantity of light sources in the candidate right bounding volume.

In the foregoing embodiment, the second spatial bounding volume is constructed based on the volumes of the light sources in the virtual scene that match the same light source type, to cause the constructed second spatial bounding volume to be more suitable for each light source of the same light source type, and prevent extremely large space of the constructed second spatial bounding volume. The second spatial bounding volume is used as the target bounding volume in the current-round partitioning, the partitioning plane for the target bounding volume in the current-round partitioning is determined, the target bounding volume is partitioned into the left bounding volume and the right bounding volume based on the partitioning plane, and partitioning is performed iteratively by using the left bounding volume and the right bounding volume separately as the target bounding volume in the current-round partitioning, to obtain the light source bounding volume hierarchy. In this way, rationality of constructing the light source bounding volume hierarchy can be improved.

In an embodiment, the determining a partitioning plane for the target bounding volume in the current-round partitioning includes: partitioning, for each of a plurality of candidate partitioning planes preset for the current-round partitioning, the target bounding volume into a candidate left bounding volume and a candidate right bounding volume based on the candidate partitioning plane; determining, based on luminous flux, a surface area, and orientation of each light source in the candidate left bounding volume, a first light source feature parameter corresponding to the candidate left bounding volume, and determining, based on luminous flux, a surface area, and orientation of each light source in the candidate right bounding volume, a second light source feature parameter corresponding to the candidate right bounding volume; determining, based on a surface area and orientation of each light source in the target bounding volume, a third light source feature parameter corresponding to the target bounding volume; determining, based on the first light source feature parameter, the second light source feature parameter, and the third light source feature parameter, a partitioning parameter corresponding to the candidate partitioning plane; and determining the partitioning plane for the target bounding volume in the current-round partitioning among the candidate partitioning planes based on partitioning parameters respectively corresponding to the candidate partitioning planes.

A first light source feature parameter is a parameter used for representing features of light sources in the candidate left bounding volume. A second light source feature parameter is a parameter used for representing features of light sources in the candidate right bounding volume. A third light source feature parameter is a parameter used for representing features of light sources in the target bounding volume. The partitioning parameter is an effect evaluation parameter used for describing partitioning of the candidate partitioning plane on the target bounding volume.

The plane partitioning iterative process in this embodiment and the node sampling iterative process in the foregoing embodiment are independent of each other, and the two iterative processes do not affect each other.

Specifically, the terminal may obtain the plurality of candidate partitioning planes preset for the current-round partitioning, and partition the target bounding volume into the candidate left bounding volume and the candidate right bounding volume based on the candidate partitioning plane for each of the plurality of candidate partitioning planes preset for the current-round partitioning. The terminal may determine the luminous flux, the surface area, and the orientation of each light source in the candidate left bounding volume and the candidate right bounding volume separately, determine, based on the luminous flux, the surface area, and the orientation of each light source in the candidate left bounding volume, the first light source feature parameter corresponding to the candidate left bounding volume, and determine, based on the luminous flux, the surface area, and the orientation of each light source in the candidate right bounding volume, the second light source feature parameter corresponding to the candidate right bounding volume. The terminal may determine, based on the surface area and the orientation of each light source in the target bounding volume, the third light source feature parameter corresponding to the target bounding volume. Further, the terminal may determine, based on the first light source feature parameter, the second light source feature parameter, and the third light source feature parameter, the partitioning parameter corresponding to the candidate partitioning plane, and determine the partitioning plane for the target bounding volume in the current-round partitioning among the candidate partitioning planes based on the partitioning parameters respectively corresponding to the candidate partitioning planes.

In an embodiment, the partitioning parameter corresponding to the candidate partitioning plane that partitions the target bounding volume into the candidate left bounding volume and the candidate right bounding volume can be calculated by the following formula:

$$\\ cos t ( L , R ) = \frac{Φ ( L ) a ( L ) M ( L ) + Φ ( R ) a ( R ) M ( R )}{a ( L ⋃ R ) M ( L ⋃ R )}$$

L represents the candidate left bounding volume. R represents the candidate right bounding volume. Φ(L) represents luminous flux of all light sources in the candidate left bounding volume. Φ(R) represents luminous flux of all light sources in the candidate right bounding volume. α(L) represents surface areas of all light sources in the candidate left bounding volume. α(R) represents surface areas of all light sources in the candidate right bounding volume. M(L) represents orientation of all light sources in the candidate left bounding volume. M(R) represents orientation of all light sources in the candidate right bounding volume. α(L∪R) represents surface areas of all light sources in the target bounding volume. M(L∪R) represents orientation of all light sources in the target bounding volume. COS t (L, R) represents the partitioning parameter corresponding to the candidate partitioning plane that partitions the target bounding volume into the candidate left bounding volume and the candidate right bounding volume. It is to be understood that, Φ(L)α(L)M(L) represents the first light source feature parameter. Φ(R)α(R)M(R) represents the second light source feature parameter. α(L∪R)M(L∪R) represents the third light source feature parameter.

In the foregoing embodiment, the target bounding volume is partitioned into the candidate left bounding volume and the candidate right bounding volume based on each candidate partitioning plane. The first light source feature parameter corresponding to the candidate left bounding volume is determined based on the luminous flux, the surface area, and the orientation of each light source in the candidate left bounding volume. In this way, accuracy of the first light source feature parameter can be improved. The second light source feature parameter corresponding to the candidate right bounding volume is determined based on the luminous flux, the surface area, and the orientation of each light source in the candidate right bounding volume. In this way, accuracy of the second light source feature parameter can be improved. The third light source feature parameter corresponding to the target bounding volume is determined based on the surface area and the orientation of each light source in the target bounding volume. In this way, accuracy of the third light source feature parameter can be improved. Further, the partitioning parameter corresponding to the candidate partitioning plane is determined based on the first light source feature parameter, the second light source feature parameter, and the third light source feature parameter, and the partitioning plane for the target bounding volume in the current-round partitioning is determined among the candidate partitioning planes based on the partitioning parameters respectively corresponding to the candidate partitioning planes. In this way, accuracy of selecting a partitioning plane is improved, thereby improving rationality of partitioning of the target bounding volume, and further improving rationality of constructing a light source bounding volume hierarchy.

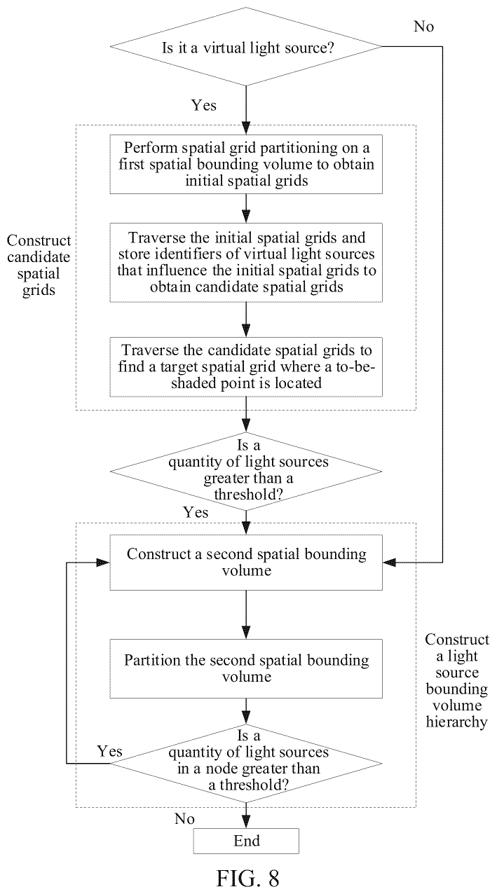

In an embodiment, as shown in FIG. 8, a terminal may determine each light source in a virtual scene. If the virtual scene includes virtual light sources, a first spatial bounding volume is constructed for the virtual light sources, and spatial grid partitioning is performed on the first spatial bounding volume to obtain initial spatial grids. The terminal may traverse the initial spatial grids and store identifiers of the virtual light sources that influence the initial spatial grids in corresponding initial spatial grids to obtain candidate spatial grids. Further, the terminal may traverse the candidate spatial grids to find a target spatial grid where a target point is located. If a quantity of virtual light sources in the target spatial grid is greater than a preset light source threshold, a second spatial bounding volume for the virtual light sources in the target spatial grid is constructed. The terminal may iteratively partition the second spatial bounding volume until a quantity of virtual light sources in a last partitioned node is less than a preset partitioning quantity threshold to obtain a virtual light source bounding volume hierarchy for the virtual light sources in the target spatial grid. If the virtual scene includes luminous object light sources, a second spatial bounding volume for the luminous object light sources in the virtual scene is constructed. The terminal may iteratively partition the second spatial bounding volume until a quantity of luminous object light sources in a last partitioned node is less than a preset partitioning quantity threshold to obtain a luminous object light source bounding volume hierarchy for the luminous object light sources in the virtual scene.

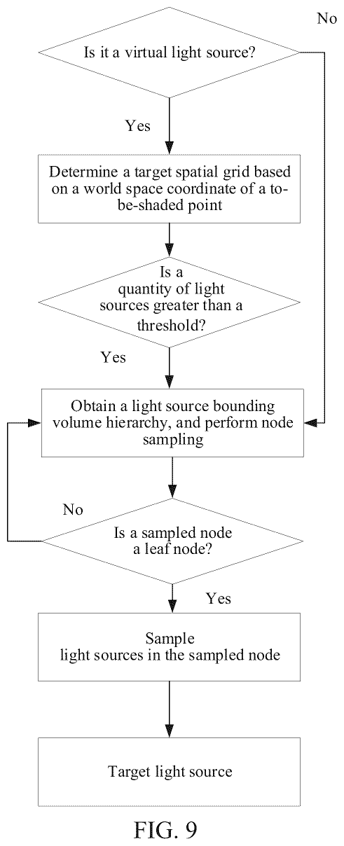

In an embodiment, as shown in FIG. 9, a terminal may determine each light source in a virtual scene, and if the virtual scene includes virtual light sources, determine a target spatial grid based on world space coordinates of a target point. The terminal may determine whether a quantity of virtual light sources in the target spatial grid is greater than a preset light source threshold. If the quantity of virtual light sources in the target spatial grid is greater than the preset light source threshold, a virtual light source bounding volume hierarchy for the target spatial grid is obtained, and node sampling is performed on the virtual light source bounding volume hierarchy. When a sampled node sampled is a leaf node of the virtual light source bounding volume hierarchy, virtual light source sampling is performed on the sampled leaf node to obtain a target light source. If the virtual scene includes luminous object light sources, a luminous object light source bounding volume hierarchy for the virtual scene is obtained, and node sampling is performed on the luminous object light source bounding volume hierarchy. When a sampled node sampled is a leaf node of the luminous object light source bounding volume hierarchy, luminous object light source sampling is performed on the sampled leaf node to obtain a target light source.

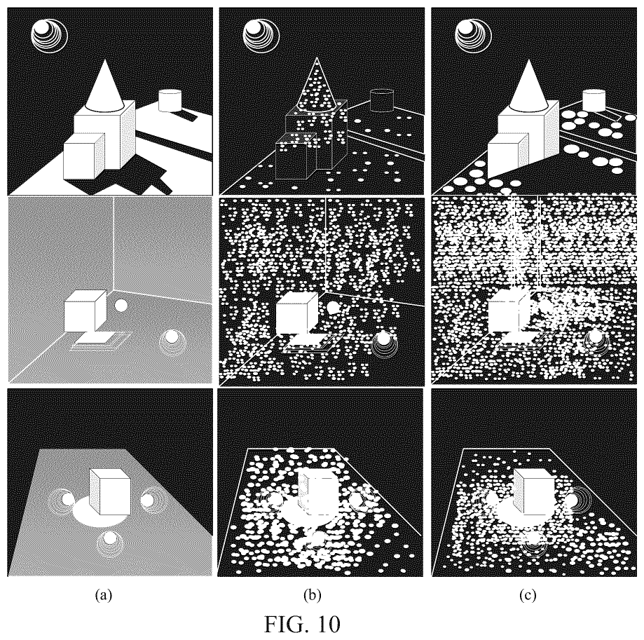

In an embodiment, as shown in FIG. 10, section (a) in FIG. 10 is an image obtained by performing lighting rendering on each virtual scene using the virtual scene rendering method of this application. Sections (b) and (c) in FIG. 10 are images respectively obtained by performing lighting rendering on virtual scenes using a conventional virtual scene rendering method. Apparently, quality of the image obtained by performing lighting rendering on each virtual scene using the virtual scene rendering method of this application is better than quality of the images obtained by performing lighting rendering on virtual scenes using the conventional virtual scene rendering method. There are a plurality of light spots and noise in the images obtained by performing lighting rendering on virtual scenes using the conventional virtual scene rendering method.

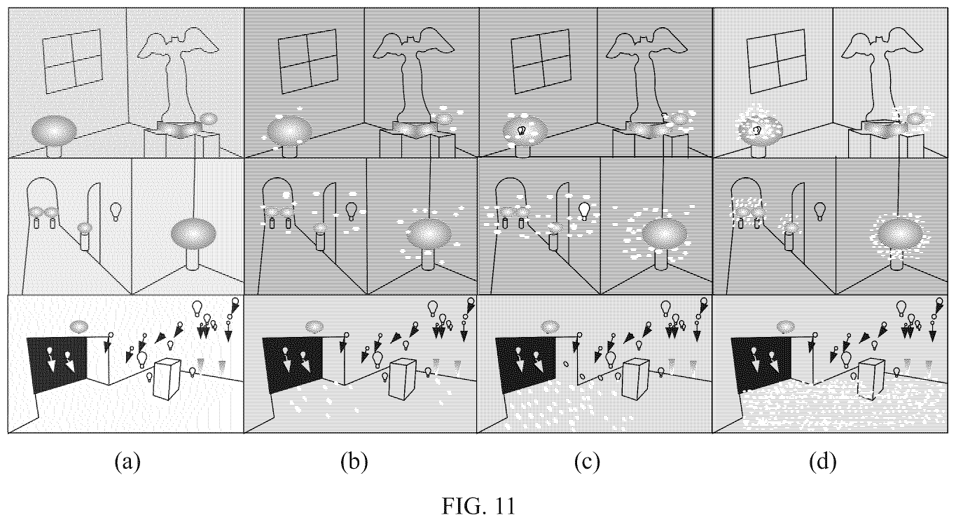

In an embodiment, as shown in FIG. 11, section (a) in FIG. 11 is an image obtained by performing lighting rendering on each virtual scene using the virtual scene rendering method of this application. Sections (b), (c), and (d) in FIG. 11 are images respectively obtained by performing lighting rendering on virtual scenes using a conventional virtual scene rendering method. Apparently, quality of the image obtained by performing lighting rendering on each virtual scene using the virtual scene rendering method of this application is better than quality of the images obtained by performing lighting rendering on virtual scenes using the conventional virtual scene rendering method. There are a plurality of light spots and noise in the images obtained by performing lighting rendering on virtual scenes using the conventional virtual scene rendering method.

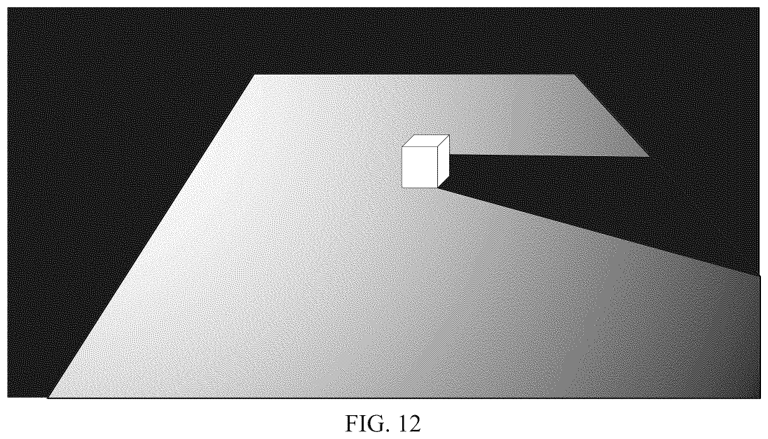

In an embodiment, lighting rendering time-consumption of the virtual scene rendering method of this application and lighting rendering time-consumption of a conventional virtual scene rendering method are tested separately based on a simple virtual scene in FIG. 12. The testing shows that the time consumed by lighting rendering using the virtual scene rendering method of this application is shorter than that using the conventional virtual scene rendering method.

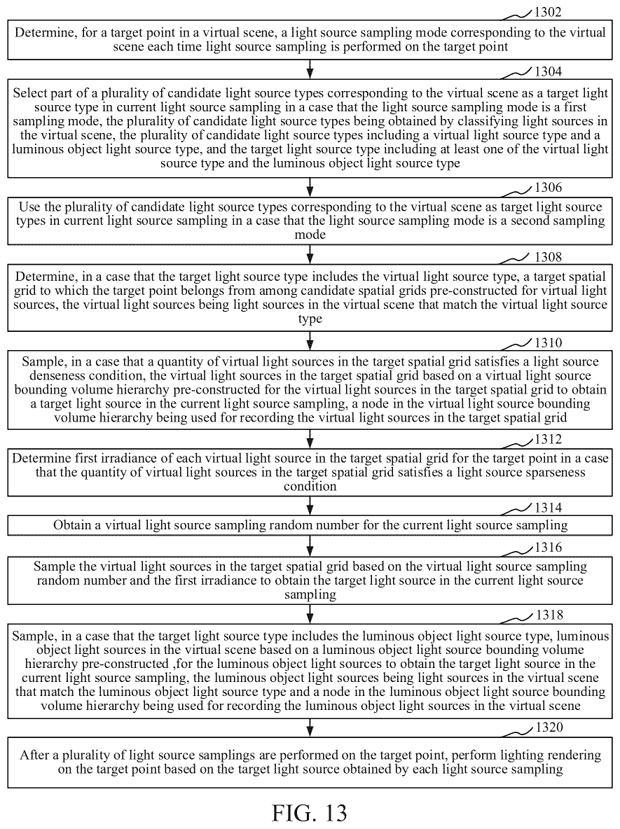

As shown in FIG. 13, in an embodiment, a virtual scene rendering method is provided. This embodiment is described by using an example in which the method is applied to the terminal 102 in FIG. 1. The method specifically includes the following steps.

Step 1302: Determine, for a target point in a virtual scene, a light source sampling mode corresponding to the virtual scene in each light source sampling performed on the target point.

Step 1304: Select part of a plurality of candidate light source types corresponding to the virtual scene as a target light source type of current light source sampling when the light source sampling mode is a first sampling mode. The plurality of candidate light source types are obtained by classifying light sources in the virtual scene. The plurality of candidate light source types include a virtual light source type and a luminous object light source type. The target light source type includes at least one of the virtual light source type and the luminous object light source type.

Step 1306: Use the plurality of candidate light source types corresponding to the virtual scene as target light source types of the current light source sampling when the light source sampling mode is a second sampling mode.

Step 1308: Determine, when the target light source type includes the virtual light source type, a target spatial grid to which the target point belongs among candidate spatial grids pre-constructed for virtual light sources, the virtual light sources being light sources in the virtual scene that match the virtual light source type.

Step 1310: Sample, when a quantity of virtual light sources in the target spatial grid satisfies a light source denseness condition, the virtual light sources in the target spatial grid based on a virtual light source bounding volume hierarchy pre-constructed for the virtual light sources in the target spatial grid to obtain a target light source of the current light source sampling, a node in the virtual light source bounding volume hierarchy being used for recording the virtual light sources in the target spatial grid.

Step 1312: Determine first irradiance of each virtual light source in the target spatial grid for the target point when the quantity of virtual light sources in the target spatial grid satisfies the light source sparseness condition.

Step 1314: Obtain a virtual light source sampling random number for the current light source sampling.

Step 1316: Sample the virtual light sources in the target spatial grid based on the virtual light source sampling random number and the first irradiance to obtain the target light source of the current light source sampling.

Step 1318: Sample, when the target light source type includes the luminous object light source type, luminous object light sources in the virtual scene based on a luminous object light source bounding volume hierarchy pre-constructed for the luminous object light sources to obtain the target light source of the current light source sampling, the luminous object light sources being light sources in the virtual scene that match the luminous object light source type, and a node in the luminous object light source bounding volume hierarchy being used for recording the luminous object light sources in the virtual scene.

Step 1320: After a plurality of light source samplings are performed on the target point, perform lighting rendering on the target point based on target light sources obtained by respective light source samplings.

This application also provides an application scenario. The virtual scene rendering method is applied in the application scenario. Specifically, the virtual scene rendering method is applicable to a scene where a virtual object in a game is rendered. For a target point in a game scene, the terminal may determine a light source sampling mode corresponding to the game scene in each light source sampling performed on the target point. Part of a plurality of candidate light source types corresponding to the game scene is selected as a target light source type of current light source sampling when a light source sampling mode is a first sampling mode. The plurality of candidate light source types are obtained by classifying light sources in the game scene. The plurality of candidate light source types include a virtual light source type and a luminous object light source type. The target light source type includes at least one of the virtual light source type and the luminous object light source type.

The terminal may use the plurality of candidate light source types corresponding to the game scene as target light source types of the current light source sampling when the light source sampling mode is a second sampling mode. When the target light source type includes a virtual light source type, a target spatial grid to which the target point belongs is determined among candidate spatial grids pre-constructed for virtual light sources, the virtual light sources being light sources in the game scene that match the virtual light source type. When a quantity of virtual light sources in the target spatial grid satisfies a light source denseness condition, the virtual light sources in the target spatial grid are sampled based on a virtual light source bounding volume hierarchy pre-constructed for the virtual light sources in the target spatial grid to obtain a target light source of the current light source sampling, a node in the virtual light source bounding volume hierarchy being used for recording the virtual light sources in the target spatial grid.
the terminal may determine the first irradiance of each virtual light source in the target spatial grid for the target point when the quantity of virtual light sources in the target spatial grid satisfies the light source sparseness condition. A virtual light source sampling random number for the current light source sampling is obtained. The virtual light sources in the target spatial grid are sampled based on the virtual light source sampling random number and the first irradiance to obtain the target light source of the current light source sampling.

When the target light source type includes the luminous object light source type, the terminal may sample luminous object light sources in the game scene based on a luminous object light source bounding volume hierarchy pre-constructed for the luminous object light sources to obtain the target light source of the current light source sampling, the luminous object light sources being light sources in the game scene that match the luminous object light source type, and a node in the luminous object light source bounding volume hierarchy being used for recording the luminous object light sources in the game scene. After a plurality of light source samplings are performed on the target point, the terminal may perform lighting rendering on the target point based on target light sources obtained by respective light source samplings.

This application also provides an application scenario. The virtual scene rendering method is applied in the application scenario. Specifically, the virtual scene rendering method is also applicable to scenarios such as film and television special effect creation, visual design, virtual reality (VR), industrial simulation, and digital cultural creation. It is to be understood that, in the scenarios such as film and television special effect creation, visual design, virtual reality (VR), industrial simulation, and digital cultural creation, lighting rendering for a virtual scene may also be involved. According to the virtual scene rendering method of this application, image rendering quality in the scenarios such as film and television special effect creation, visual design, virtual reality (VR), industrial simulation, and digital cultural creation can be improved.

It is to be understood that, although the steps in the flowcharts of the foregoing embodiments are displayed in sequence, these steps are not necessarily performed in sequence. Unless otherwise explicitly specified in this application, execution of the steps is not strictly limited, and the steps may be performed in other sequences. Moreover, at least some of the steps in each embodiment may include a plurality of sub-steps or a plurality of stages. The sub-steps or stages are not necessarily performed at the same moment but may be performed at different moments. Execution of the sub-steps or stages is not necessarily sequentially performed, but may be performed alternately with other steps or at least some of sub-steps or stages of other steps.

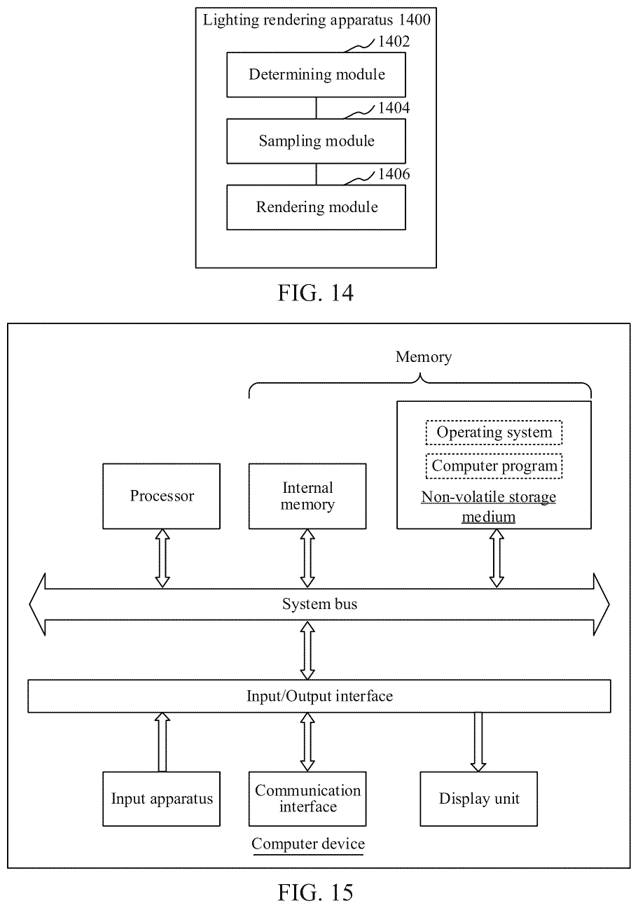

In an embodiment, as shown in FIG. 14, a virtual scene rendering apparatus 1400 is provided. A software module or a hardware module, or a combination thereof may be used in the apparatus to form a part of a computer device. The apparatus specifically includes:
a determining module 1402, configured to determine a target light source type among a plurality of candidate light source types for a target point in a virtual scene;
a sampling module 1404, configured to perform light source sampling on the target point to obtain a target light source that matches the target light source type; and
a rendering module 1406, configured to render the target point based on the target light source.

In an embodiment, the determining module 1402 is further configured to determine a light source sampling mode corresponding to the virtual scene; select a corresponding subset of the plurality of candidate light source types as the target light source type of the current light source sampling when the light source sampling mode is a first sampling mode; and use the plurality of candidate light source types as target light source types when the light source sampling mode is a second sampling mode.

In an embodiment, the determining module 1402 is further configured to determine total luminous flux of each of the plurality of candidate light source types when the light source sampling mode is the first sampling mode; obtain a type sampling random number; and determine the target light source type among the plurality of candidate light source types based on the type sampling random number and the total luminous flux of each light source type.

In an embodiment, the determining module 1402 is further configured to determine, based on the total luminous flux of each light source type, a sampling weight range corresponding to each light source type, the total luminous flux being positively correlated with the sampling weight range; and determine, as the target light source type, a light source type corresponding to a sampling weight range within which the type sampling random number falls.

In an embodiment, the sampling module 1404 is further configured to determine, when the target light source type includes a virtual light source type, a target spatial grid to which the target point belongs among candidate spatial grids pre-constructed for virtual light sources, the virtual light sources being light sources in the virtual scene that match the virtual light source type; and sample virtual light sources in the target spatial grid to obtain the target light source corresponding to the current light source sampling and matching the target light source type.

In an embodiment, the sampling module 1404 is further configured to sample, when a quantity of virtual light sources in the target spatial grid satisfies a light source denseness condition, the virtual light sources in the target spatial grid based on a virtual light source bounding volume hierarchy pre-constructed for the virtual light sources in the target spatial grid to obtain the target light source that matches the target light source type, a node in the virtual light source bounding volume hierarchy being used for recording the virtual light sources in the target spatial grid.

In an embodiment, the sampling module 1404 is further configured to determine first irradiance of each virtual light source in the target spatial grid for the target point when the quantity of virtual light sources in the target spatial grid satisfies the light source sparseness condition; obtain a virtual light source sampling random number; and sample the virtual light sources in the target spatial grid based on the virtual light source sampling random number and the first irradiance to obtain the target light source that matches the target light source type.

In an embodiment, the apparatus further includes:
a first construction module, configured to determine, for each virtual light source in the virtual scene, a lighting influence range of the virtual light source based on a lighting influence radius and a lighting influence angle of the virtual light source; construct a first spatial bounding volume based on the lighting influence range of each virtual light source in the virtual scene, the first spatial bounding volume enclosing lighting influence ranges of all the virtual light sources in the virtual scene; and perform spatial grid partitioning on the first spatial bounding volume to obtain candidate spatial grids for the virtual light source, in each candidate spatial grid, a light source identifier of a virtual light source that influences the candidate spatial grid being recorded.

In an embodiment, the sampling module 1404 is further configured to sample, when the target light source type includes a luminous object light source type, luminous object light sources in the virtual scene based on a luminous object light source bounding volume hierarchy pre-constructed for the luminous object light sources to obtain the target light source that matches the target light source type, the luminous object light sources being light sources in the virtual scene that match the luminous object light source type, and a node in the luminous object light source bounding volume hierarchy being used for recording the luminous object light sources in the virtual scene.

In an embodiment, the sampling module 1404 is further configured to determine a light source bounding volume hierarchy pre-constructed for the target light source type, a node in the light source bounding volume hierarchy being used for recording light sources in the virtual scene that match the target light source type; use a root node of the light source bounding volume hierarchy as a target node of current-round node sampling, and determining a node sampling weight of each sub-node under the target node to the target point; obtain a node sampling random number for the current-round node sampling; determine a sampled node of the current-round node sampling among sub-nodes under the target node based on the node sampling random number and the node sampling weight; and use the sampled node as the target node of the current-round node sampling, consider next-round node sampling as the current-round node sampling, iteratively perform the operation of determining a node sampling weight of each sub-node under the target node to the target point until a node sampling iteration stop condition is satisfied, and sample light sources that are in a sampled node determined in a final round and that match the target light source type to obtain the target light source of the current light source sampling.

In an embodiment, the sampling module 1404 is further configured to determine, for each sub-node under the target node based on luminous flux of each light source in the sub-node, node luminous flux corresponding to the sub-node; determine, based on a relative position of the sub-node and the target point, a node orientation parameter corresponding to the sub-node; and determine the node sampling weight of the sub-node to the target point based on the node luminous flux, the node orientation parameter, and a distance between the sub-node and the target point.

In an embodiment, the sampling module 1404 is further configured to calculate second irradiance of each light source that is in the sampled node determined in the final round and that matches the target light source type for the target point; obtain a light source sampling random number; and sample, based on the light source sampling random number and the second irradiance, the light sources that are in the sampled node determined in the final round and that match the target light source type to obtain the target light source.

In an embodiment, the target light source of the current light source sampling is obtained by sampling based on the light source bounding volume hierarchy pre-constructed for the target light source type. The apparatus further includes:
a second construction module, configured to construct a second spatial bounding volume based on volumes of light sources in the virtual scene that match a same light source type, the second spatial bounding volume enclosing the light sources that match the same light source type; use the second spatial bounding volume as a target bounding volume in current-round partitioning, and determining a partitioning plane for the target bounding volume in the current-round partitioning; partition the target bounding volume into a left bounding volume and a right bounding volume based on the partitioning plane; and use the left bounding volume and the right bounding volume separately as the target bounding volume in the current-round partitioning, considering next-round partitioning as the current-round partitioning, and iteratively performing the operation of determining a partitioning plane for the target bounding volume in the current-round partitioning until a partitioning iteration stop condition is satisfied to obtain the light source bounding volume hierarchy.

In an embodiment, the second construction module is further configured to partition, for each of a plurality of candidate partitioning planes preset for the current-round partitioning, the target bounding volume into a candidate left bounding volume and a candidate right bounding volume based on the candidate partitioning plane; determine, based on luminous flux, a surface area, and orientation of each light source in the candidate left bounding volume, a first light source feature parameter corresponding to the candidate left bounding volume, and determining, based on luminous flux, a surface area, and orientation of each light source in the candidate right bounding volume, a second light source feature parameter corresponding to the candidate right bounding volume; determine, based on a surface area and orientation of each light source in the target bounding volume, a third light source feature parameter corresponding to the target bounding volume; determine, based on the first light source feature parameter, the second light source feature parameter, and the third light source feature parameter, a partitioning parameter corresponding to the candidate partitioning plane; and determine the partitioning plane for the target bounding volume in the current-round partitioning among the candidate partitioning planes based on partitioning parameters respectively corresponding to the candidate partitioning planes.

In an embodiment, the rendering module 1406 is further configured to sample, for each target light source, at least one light source point from the target light source; and render the target point based on the light source points respectively corresponding to the target light sources.

In an embodiment, the rendering module 1406 is further configured to determine a color of emergent light of the target point based on the emissive light color of each light source point, a material parameter corresponding to a surface material of the target point, a direction vector of incident light, and a surface normal vector of the target point, the incident light referring to light rays that reach the target point, and the emergent light referring to light rays emitted from the target point; and render the target point based on the color of the emergent light.

The virtual scene rendering apparatus determines, for the target point in the virtual scene, the target light source type of the current light source sampling among the plurality of candidate light source types in each light source sampling performed on the target point. Light source sampling is performed on the target point to obtain the target light source corresponding to the current light source sampling and matching the target light source type. In each light source sampling, the target light source type of the current light source sampling is determined among the plurality of candidate light source types, and the target light source that matches the target light source type is sampled from the plurality of candidate light source types. Therefore, there is a high probability that light sources obtained by a plurality of light source samplings on the target point include light sources corresponding to a plurality of candidate light source types, thereby avoiding singularity of light source types. In this way, after a plurality of light source samplings are performed on the target point, the target point is rendered based on target light sources obtained by respective light source samplings to improve the rendering effect of the target point, thereby improve rendering quality of an image.

Each module in the virtual scene rendering apparatus may be implemented entirely or partially through software, hardware, or a combination thereof. Each module can be embedded in or independent of a processor in a computer device in a form of hardware, or can be stored in a memory in the computer device in a form of software, so that the processor can be called to perform corresponding operations of each of the foregoing modules. In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module.

In an embodiment, a computer device is provided. The computer device may be a terminal. A diagram of an internal structure of the computer device may be shown as FIG. 15. The computer device includes a processor, a memory, an input/output interface, a communication interface, a display unit, and an input apparatus. The processor, the memory, and the input/output interface are connected by a system bus. The communication interface, the display unit, and input apparatus are connected to the system bus via the input/output interface. The processor of the computer device is configured to provide computation and control abilities. The memory of the computer device includes a non-volatile storage medium and an internal memory. The non-volatile storage medium has an operating system and computer-readable instructions stored thereon. The internal memory provides an operating environment for the operating system and the computer-readable instructions in the non-volatile storage medium. The input/output interface of the computer device is used for exchanging information between the processor and an external device. The communication interface of the computer device is used for wired or wireless communication with an external terminal. The wireless communication may be implemented via Wi-Fi, a mobile cellular network, near field communication (NFC), or another technology. The computer-readable instructions are executed by the processor to implement a virtual scene rendering method. The display unit of the computer device is configured to form a visually visible picture, and may be a display screen, a projection device, or a virtual reality imaging device. The display screen may be a liquid crystal display screen or an e-ink display screen. The input apparatus of the computer device may be a touch layer covering the display screen, or may be a button, a trackball, or a touchpad disposed on a housing of the computer device, or may be an external keyboard, touchpad, a mouse or the like.

A person skilled in the art may understand that the structure shown in FIG. 15 is merely a block diagram of a partial structure related to a solution in this application, and does not constitute a limitation to the computer device to which the solution in this application is applied. Specifically, the computer device may include more components or fewer components than those shown in FIG. 15, or some components may be combined, or a different component deployment may be used.

In an embodiment, a computer device is further provided, including a memory and one or more processors, the memory having computer-readable instructions stored therein, and when executing the computer-readable instructions, the processor implementing steps in each of the foregoing method embodiments.

In an embodiment, one or more computer-readable storage media are provided, having computer-readable instructions stored thereon, and the computer-readable instructions, when being executed by one or more processors, implementing steps in each of the foregoing method embodiments.

In an embodiment, a computer program product is provided, including computer-readable instructions, and the computer-readable instructions, when being executed by one or more processors, implementing steps in each of the foregoing method embodiments.

User information (including but not limited to user device information, user personal information, and the like) and data (including but not limited to data used for analysis, stored data, displayed data, and the like) involved in this application are information and data all authorized by the user or fully authorized by all parties, and collection, use, and processing of related data need to comply with relevant laws, regulations, and standards of relevant countries and regions.

A person of ordinary skill in the art may understand that all or some of procedures of the method in the foregoing embodiments may be implemented by computer-readable instructions instructing relevant hardware. The computer-readable instructions may be stored in a non-volatile computer-readable storage medium. When the computer-readable instructions are executed, the procedures of the foregoing method embodiments may be implemented. References to the memory, the storage, the database, or other medium used in the embodiments provided in this application may all include at least one of a non-volatile and a volatile memory. The non-volatile memory may include a read-only memory (ROM), a magnetic tape, a floppy disk, a flash memory, an optical memory, or the like. The volatile memory may include a random access memory (RAM) or an external high-speed cache memory. As an illustration rather than a limitation, the RAM may come in many forms, such as a static random access memory (SRAM) or a dynamic random access memory (DRAM).

Technical features of the foregoing embodiments may be randomly combined. To make description concise, not all possible combinations of the technical features in the foregoing embodiments are described. However, the combinations of these technical features shall be considered as falling within the scope recorded by this specification provided that no conflict exists.

The foregoing embodiments only describe several implementations of this application specifically and in detail, but cannot be construed as a limitation to the patent scope of this application. For a person of ordinary skill in the art, several transformations and improvements can be made without departing from the idea of this application. These transformations and improvements belong to the protection scope of this application. Therefore, the protection scope of the patent of this application shall be subject to the appended claims.

What is claimed is:

1. A virtual scene rendering method performed by a computer device, the method comprising:
determining a target light source type among a plurality of candidate light source types for a target point in a virtual scene;
performing light source sampling on the target point to obtain a target light source that matches the target light source type; and
rendering the target point based on the target light source.

2. The method according to claim 1, wherein the determining a target light source type among a plurality of candidate light source types comprises:
determining a light source sampling mode corresponding to the virtual scene; and
selecting a corresponding subset of the plurality of candidate light source types as a target light source type when the light source sampling mode is a first sampling mode.

3. The method according to claim 2, wherein the selecting a corresponding subset of the plurality of candidate light source types as a target light source type when the light source sampling mode is a first sampling mode comprises:
determining total luminous flux of each of the plurality of candidate light source types; and
determining the target light source type among the plurality of candidate light source types based on a type sampling random number and the total luminous flux of each light source type.

4. The method according to claim 1, wherein the performing light source sampling on the target point to obtain a target light source that matches the target light source type comprises:
when the target light source type comprises a virtual light source type, determining a target spatial grid to which the target point belongs among candidate spatial grids pre-constructed for virtual light sources, the virtual light sources being light sources in the virtual scene that match the virtual light source type; and
sampling virtual light sources in the target spatial grid to obtain the target light source that matches the target light source type.

5. The method according to claim 1, wherein the performing light source sampling on the target point to obtain a target light source that matches the target light source type comprises:
when the target light source type comprises a luminous object light source type, sampling luminous object light sources in the virtual scene based on a luminous object light source bounding volume hierarchy pre-constructed for the luminous object light sources to obtain the target light source that matches the target light source type,
the luminous object light sources being light sources in the virtual scene that match the luminous object light source type, and a node in the luminous object light source bounding volume hierarchy being used for recording the luminous object light sources in the virtual scene.

6. The method according to claim 1, wherein the performing light source sampling on the target point to obtain a target light source that matches the target light source type comprises:
determining a light source bounding volume hierarchy pre-constructed for the target light source type, a node in the light source bounding volume hierarchy being used for recording light sources in the virtual scene that match the target light source type;
using a root node of the light source bounding volume hierarchy as a target node of current-round node sampling, and determining a node sampling weight of each sub-node under the target node to the target point;
obtaining a node sampling random number for the current-round node sampling;
determining a sampled node of the current-round node sampling among sub-nodes under the target node based on the node sampling random number and the node sampling weight; and
using the sampled node as the target node of the current-round node sampling, considering next-round node sampling as the current-round node sampling, iteratively performing the operation of determining a node sampling weight of each sub-node under the target node to the target point until a node sampling iteration stop condition is satisfied, and sampling light sources that are in a sampled node determined in the final round and that match the target light source type to obtain the target light source.

7. The method according to claim 6, wherein the target light source is obtained by sampling based on the light source bounding volume hierarchy pre-constructed for the target light source type; and the method further comprises:
constructing a second spatial bounding volume based on volumes of light sources in the virtual scene that match a same light source type, the second spatial bounding volume enclosing the light sources that match the same light source type;
using the second spatial bounding volume as a target bounding volume in current-round partitioning, and determining a partitioning plane for the target bounding volume in the current-round partitioning;
partitioning the target bounding volume into a left bounding volume and a right bounding volume based on the partitioning plane; and
using the left bounding volume and the right bounding volume separately as the target bounding volume in the current-round partitioning, considering next-round partitioning as the current-round partitioning, and iteratively performing the operation of determining a partitioning plane for the target bounding volume in the current-round partitioning until a partitioning iteration stop condition is satisfied to obtain the light source bounding volume hierarchy.

8. The method according to claim 1, wherein the rendering the target point based on the target light sources obtained by respective light source samplings comprises:
sampling, for each target light source, at least one light source point from the target light source; and
rendering the target point based on the light source points respectively corresponding to the target light sources.

9. The method according to claim 8, wherein the rendering the target point based on the light source points respectively corresponding to the target light sources comprises:
determining a color of emergent light of the target point based on the emissive light color of each light source point, a material parameter corresponding to a surface material of the target point, a direction vector of incident light, and a surface normal vector of the target point, the incident light referring to light rays that reach the target point, and the emergent light referring to light rays emitted from the target point; and
rendering the target point based on the color of the emergent light.

10. A computer device, comprising a memory and one or more processors, the memory having computer-readable instructions stored therein, and the computer-readable instructions, when executed by the processor, causing the computer device to perform a virtual scene rendering method including:
determining a target light source type among a plurality of candidate light source types for a target point in a virtual scene;
performing light source sampling on the target point to obtain a target light source that matches the target light source type; and
rendering the target point based on the target light source.

11. The computer device according to claim 10, wherein the determining a target light source type among a plurality of candidate light source types comprises:
determining a light source sampling mode corresponding to the virtual scene; and
selecting a corresponding subset of the plurality of candidate light source types as a target light source type when the light source sampling mode is a first sampling mode.

12. The computer device according to claim 11, wherein the selecting a corresponding subset of the plurality of candidate light source types as a target light source type when the light source sampling mode is a first sampling mode comprises:
determining total luminous flux of each of the plurality of candidate light source types; and
determining the target light source type among the plurality of candidate light source types based on a type sampling random number and the total luminous flux of each light source type.

13. The computer device according to claim 10, wherein the performing light source sampling on the target point to obtain a target light source that matches the target light source type comprises:
when the target light source type comprises a virtual light source type, determining a target spatial grid to which the target point belongs among candidate spatial grids pre-constructed for virtual light sources, the virtual light sources being light sources in the virtual scene that match the virtual light source type; and
sampling virtual light sources in the target spatial grid to obtain the target light source that matches the target light source type.

14. The computer device according to claim 10, wherein the performing light source sampling on the target point to obtain a target light source that matches the target light source type comprises:
when the target light source type comprises a luminous object light source type, sampling luminous object light sources in the virtual scene based on a luminous object light source bounding volume hierarchy pre-constructed for the luminous object light sources to obtain the target light source that matches the target light source type,
the luminous object light sources being light sources in the virtual scene that match the luminous object light source type, and a node in the luminous object light source bounding volume hierarchy being used for recording the luminous object light sources in the virtual scene.

15. The computer device according to claim 10, wherein the performing light source sampling on the target point to obtain a target light source that matches the target light source type comprises:
determining a light source bounding volume hierarchy pre-constructed for the target light source type, a node in the light source bounding volume hierarchy being used for recording light sources in the virtual scene that match the target light source type;
using a root node of the light source bounding volume hierarchy as a target node of current-round node sampling, and determining a node sampling weight of each sub-node under the target node to the target point;
obtaining a node sampling random number for the current-round node sampling;
determining a sampled node of the current-round node sampling among sub-nodes under the target node based on the node sampling random number and the node sampling weight; and
using the sampled node as the target node of the current-round node sampling, considering next-round node sampling as the current-round node sampling, iteratively performing the operation of determining a node sampling weight of each sub-node under the target node to the target point until a node sampling iteration stop condition is satisfied, and sampling light sources that are in a sampled node determined in the final round and that match the target light source type to obtain the target light source.

16. The computer device according to claim 15, wherein the target light source is obtained by sampling based on the light source bounding volume hierarchy pre-constructed for the target light source type; and the method further comprises:
constructing a second spatial bounding volume based on volumes of light sources in the virtual scene that match a same light source type, the second spatial bounding volume enclosing the light sources that match the same light source type;
using the second spatial bounding volume as a target bounding volume in current-round partitioning, and determining a partitioning plane for the target bounding volume in the current-round partitioning;
partitioning the target bounding volume into a left bounding volume and a right bounding volume based on the partitioning plane; and
using the left bounding volume and the right bounding volume separately as the target bounding volume in the current-round partitioning, considering next-round partitioning as the current-round partitioning, and iteratively performing the operation of determining a partitioning plane for the target bounding volume in the current-round partitioning until a partitioning iteration stop condition is satisfied to obtain the light source bounding volume hierarchy.

17. The computer device according to claim 10, wherein the rendering the target point based on the target light sources obtained by respective light source samplings comprises:
sampling, for each target light source, at least one light source point from the target light source; and
rendering the target point based on the light source points respectively corresponding to the target light sources.

18. The computer device according to claim 17, wherein the rendering the target point based on the light source points respectively corresponding to the target light sources comprises:
determining a color of emergent light of the target point based on the emissive light color of each light source point, a material parameter corresponding to a surface material of the target point, a direction vector of incident light, and a surface normal vector of the target point, the incident light referring to light rays that reach the target point, and the emergent light referring to light rays emitted from the target point; and
rendering the target point based on the color of the emergent light.

19. One or more non-transitory computer-readable storage media, having computer-readable instructions stored thereon, the computer-readable instructions, when being executed by one or more processors of a computer device, causing the computer device to perform a virtual scene rendering method including:
determining a target light source type among a plurality of candidate light source types for a target point in a virtual scene;
performing light source sampling on the target point to obtain a target light source that matches the target light source type; and
rendering the target point based on the target light source.

20. The non-transitory computer-readable storage media according to claim 19, wherein the rendering the target point based on the target light sources obtained by respective light source samplings comprises:
sampling, for each target light source, at least one light source point from the target light source; and
rendering the target point based on the light source points respectively corresponding to the target light sources.
